(19) United States
(12) Patent Application Publication
(10) Pub. No.: US 2024/0244996 A1
(43) Pub. Date: Jul. 25, 2024

(54) AGRICULTURAL HARVESTERS AND SYSTEMS FOR COLLABORATIVE RESIDUE SPREAD CONTROL

(71) Applicant: Deere & Company, Moline, IL (US)

(72) Inventor: Nathan R. VANDIKE, Geneseo, IL (US)

(73) Assignee: Deere & Company, Moline, IL (US)

(21) Appl. No.: 18/158,722

(22) Filed: Jan. 24, 2023

(51) Int. Cl. A01D 41/12; A01D 41/127

(52) U.S. Cl. CPC A01D 41/1243; A01D 41/127

(57) ABSTRACT

Provided is an agricultural harvester including processing circuitry configured to cause the agricultural harvester to receive a first signal from another agricultural harvester, the first signal indicating a residue spread performance, the residue spread performance corresponding to a residue spread of the agricultural harvester in a first harvesting area, modify an operation parameter of the agricultural harvester based on the residue spread performance to obtain a modified operation parameter, and control a residue spread of the agricultural harvester in a second harvesting area according to the modified operation parameter.

### FIELD

Some example embodiments provide agricultural harvesters, and systems including the same, for collaborative residue spread control to provide improved crop residue spread.

### BACKGROUND

There are a wide variety of different types of agricultural machines. Some agricultural machines include harvesters, such as combine harvesters, sugar cane harvesters, cotton harvesters, self-propelled forage harvesters, and windrowers. Some harvesters may be fitted with different types of heads to harvest different types of crops.

As a harvester travels across and completes a harvesting operation, the byproducts from the harvesting operation, called material other than grain (MOG), are dispersed by the agricultural harvester across the field.

### SUMMARY

Some example embodiments provide an agricultural harvester including processing circuitry configured to cause the agricultural harvester to receive a first signal from another agricultural harvester, the first signal indicating a residue spread performance, the residue spread performance corresponding to a residue spread of the agricultural harvester in a first harvesting area, modify an operation parameter of the agricultural harvester based on the residue spread performance to obtain a modified operation parameter, and control a residue spread of the agricultural harvester in a second harvesting area according to the modified operation parameter.

Some example embodiments provide an agricultural harvester including processing circuitry configured to cause the agricultural harvester to detect a residue spread performance corresponding to a residue spread of another agricultural harvester, transmit a first signal to the other agricultural harvester, the first signal indicating the residue spread performance, receive a second signal from the other agricultural harvester in response to the first signal, the second signal indicating a modified operation parameter, and control a residue spread of the agricultural harvester in a first harvesting area according to the modified operation parameter.

Some example embodiments provide a system including a first agricultural harvester configured to detect a residue spread performance corresponding to a residue spread of a second agricultural harvester in a first harvesting area, and transmit a first signal to the second agricultural harvester, the first signal indicating the residue spread performance, and the second agricultural harvester configured to modify an operation parameter of the second agricultural harvester based on the residue spread performance to obtain a modified operation parameter, and control a residue spread of the second agricultural harvester in a second harvesting area according to the modified operation parameter.

Some example embodiments provide an agricultural harvester including receiving means to receive a first signal from another agricultural harvester, the first signal indicating a residue spread performance, the residue spread performance corresponding to a residue spread of the agricultural harvester in a first harvesting area, modifying means to modify an operation parameter of the agricultural harvester based on the residue spread performance to obtain a modified operation parameter, and controlling means to control a residue spread of the agricultural harvester in a second harvesting area according to the modified operation parameter.

Some example embodiments provide an agricultural harvester including detecting means to detect a residue spread performance corresponding to a residue spread of another agricultural harvester, transmitting means to transmit a first signal to the other agricultural harvester, the first signal indicating the residue spread performance, receiving means to receive a second signal from the other agricultural harvester in response to the first signal, the second signal indicating a modified operation parameter, and controlling means to control a residue spread of the agricultural harvester in a first harvesting area according to the modified operation parameter.

Some example embodiments provide a non-transitory computer-readable medium storing instructions that, when executed by at least one processor of an agricultural harvester, cause the at least one processor to receive a first signal from another agricultural harvester, the first signal indicating a residue spread performance, the residue spread performance corresponding to a residue spread of the agricultural harvester in a first harvesting area, modify an operation parameter of the agricultural harvester based on the residue spread performance to obtain a modified operation parameter, and control a residue spread of the agricultural harvester in a second harvesting area according to the modified operation parameter.

Some example embodiments provide a non-transitory computer-readable medium storing instructions that, when executed by at least one processor of an agricultural harvester, cause the at least one processor to detect a residue spread performance corresponding to a residue spread of another agricultural harvester, transmit a first signal to the other agricultural harvester, the first signal indicating the residue spread performance, receive a second signal from the other agricultural harvester in response to the first signal, the second signal indicating a modified operation parameter, and control a residue spread of the agricultural harvester in a first harvesting area according to the modified operation parameter

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1 is a partial pictorial, partial schematic illustration of a self-propelled agricultural harvester 100, according to some example embodiments;

FIG. 2 is a flow chart of a collaborative process for detecting, and modifying an operation parameter based on, a residue spread performance, according to some example embodiments;

FIG. 3 illustrates a residue spread operation performed by a first agricultural harvester 202 and a second agricultural harvester 204, according to some example embodiments;

FIGS. 4A and 4B illustrate a flow chart and corresponding table 300A for explanation of some example embodiments of operation 230 of FIG. 2 in which an operation parameter adjustment(s) is determined based on a received residue spread performance;

FIGS. 5A and 5B illustrate a flow chart and corresponding table 300B for explanation of some example embodiments of operation 230 of FIG. 2 in which an operation parameter adjustment(s) is determined based on both a received residue spread performance and an environmental parameter(s);

FIGS. 6A and 6B illustrate a flow chart and corresponding table 300C for explanation of some example embodiments of operation 230 of FIG. 2 in which an operation parameter adjustment(s) is determined based on both a received residue spread performance and a previous environmental parameter(s); and

FIG. 7 is a diagram of a system for detecting, and modifying an operation parameter based on, a residue spread performance, according to some example embodiments.

### DETAILED DESCRIPTION

Uniform residue spreading may increase the overall production of a field. Non-uniform residue coverage causes a variety of different challenges. For instance, nutrients in the residue will be concentrated under the bands of high residue. Or for instance, pests such as insects, slugs, and rodents reside in larger residue piles. Or for instance, weed seeds and grain lost through the combine will be concentrated in the residue patches. Or for instance, herbicide effectiveness will be compromised because the herbicides are blocked from reaching the soil by residue patches. Or for instance, windrows or piles of residue may reduce performance of a planter because the seed openers have difficulty cutting through excessive residue, and seeds are not planted in the soil. Or for instance, non-uniform residue coverage may also cause non-uniform soil temperature and moisture conditions. The soil covered by greater amounts of residue will be several degrees cooler and will be more moist than bare soil causing differences in crop development. Or for instance, residue spread farther than a cut edge of a row (e.g., farther than a width of a header of the agricultural harvester) may collect on a crop of the adjacent row. Subsequently, when the adjacent row is harvested, the collected residue in combination with the crop of the adjacent row provides an excessive amount of vegetation to be cut by the header, resulting in the vegetation becoming compacted in a corner of the header. This compacted vegetation may result in delay in clearing the compacted vegetation from the header, reduced harvesting performance, and/or damage to the header.

Performance of a residue spreader on an agricultural harvester may be deleteriously affected based on a number of different criteria. For example, areas with variance in vegetation such as intensity of weeds or crop plants may have deleterious effects on the residue spreading operation. Increased vegetation may increase the mass of residue being spread by the agricultural harvester.

Or for example, topographic characteristics affect the orientation of the agricultural harvester (e.g., pitch and roll) as it travels over the terrain. This orientation of the agricultural harvester affects the way in which the harvester spreads residue across the field. For instance, when agricultural harvester rolls to either the left or right side, the uphill side may have a shorter residue spread distance.

Or for example, areas with variance in vegetation moisture, such as moisture in the weed and crop plants, may have deleterious effects on the residue spreading operation. For instance, material having a higher moisture may spread in a smaller width due to increased friction in the residue system or due to the increased mass of the material. Or in some instances, material having a higher moisture may spread farther because of increased inertia of the material that resists the effects of air resistance or wind.

Or for example, wind may affect residue spread operations. For instance, a crosswind with respect to a travel direction of the agricultural harvester may shift a residue spread in a lateral direction. Also, a wind blowing in a direction parallel to the travel direction of the agricultural harvester may shift a residue spread along the direction parallel to the travel direction of the agricultural harvester. The extent of the shift in residue spread due to wind may be proportional to a strength of the wind.

In view of the above challenges, it would be desirable to accurately detect residue spread performance and enable adjustment of residue spread control in response to the detected residue spread performance to improve the coverage and uniformity of the residue spread. Conventional devices and methods are unable to accurately detect residue spread performance. For example, conventional devices and methods detect residue spread performance using cameras and/or other sensors mounted on the agricultural harvester spreading the residue. Such cameras and/or other sensors are unable to accurately detect residue spread performance due to a large cloud of dust and debris generating during residue spread operation that effectively blinds the cameras and/or other sensors as to the extent of coverage, and uniformity of, residue spread. Accordingly, the conventional devices and methods are unable to detect residue spread performance with sufficient accuracy.

However, according to some example embodiments, improved devices and methods are provided for detecting residue spread performance. For example, the improved devices and methods may detect residue spread performance according to a collaborative approach. In this collaborative approach, the residue spread performance of a first agricultural harvester may be detected using sensors on a second agricultural harvester that is remote from the first agricultural harvester, and thus, able to detect the residue spread performance without being hindered, or while being less hindered, by the dust and debris generated by the residue spread operation. Accordingly, the improved devices and methods overcome the deficiencies of the conventional devices and methods to at least improve the accuracy of residue spread performance detection.

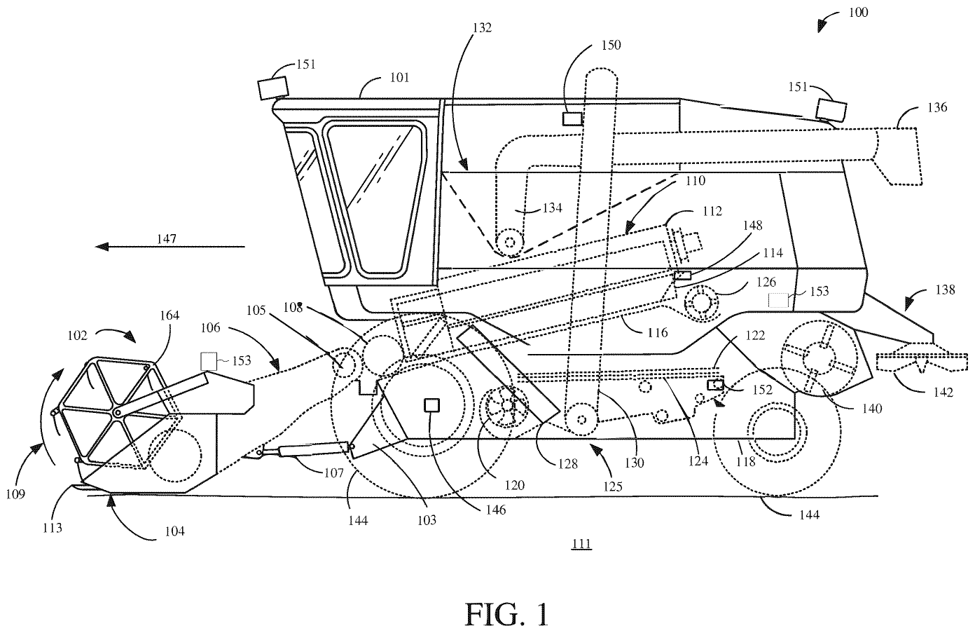

FIG. 1 is a partial pictorial, partial schematic illustration of a self-propelled agricultural harvester 100 (may also be referred to herein as an agricultural machine 100), according to some example embodiments. In the illustrated example, the agricultural harvester 100 is a combine harvester. Further, although combine harvesters are provided as examples throughout the present disclosure, it will be appreciated that the present description is also applicable to other types of harvesters, such as cotton harvesters, sugarcane harvesters, self-propelled forage harvesters, windrowers, or other agricultural work machines. Consequently, the present disclosure is intended to encompass the various types of harvesters described and is, thus, not limited to combine harvesters.

As shown in FIG. 1, the agricultural harvester 100 illustratively includes an operator compartment 101, which may have a variety of different operator interface mechanisms for controlling the agricultural harvester 100. The agricultural harvester 100 may include front-end equipment, such as a header 102, and a cutter generally indicated at 104. In the illustrated example, the cutter 104 is included on the header 102. The agricultural harvester 100 may also include a feeder house 106, a feed accelerator 108, and/or a thresher generally indicated at 110. The feeder house 106 and the feed accelerator 108 may form part of a material handling subsystem 125. The header 102 may be pivotally coupled to a frame 103 of the agricultural harvester 100 along a pivot axis 105. One or more actuators 107 (may be referred to herein in singular or plural form) may drive movement of the header 102 about the axis 105 in the direction generally indicated by an arrow 109. Thus, a vertical position of the header 102 (the header height) above ground 111 over which the header 102 travels is controllable by actuating the actuator 107. While not shown in FIG. 1, the agricultural harvester 100 may also include one or more actuators that operate to apply a tilt angle, a roll angle, or both to the header 102 or portions of the header 102. Tilt refers to an angle at which the cutter 104 engages the crop. The tilt angle is increased, for example, by controlling the header 102 to point a distal edge 113 of the cutter 104 more toward the ground 111. The tilt angle may be decreased by controlling the header 102 to point the distal edge 113 of the cutter 104 more away from the ground 111. The roll angle refers to the orientation of the header 102 about the front-to-back longitudinal axis of the agricultural harvester 100.

The thresher 110 illustratively includes a threshing rotor 112 and a set of concaves 114. Further, the agricultural harvester 100 may also include a separator 116. The agricultural harvester 100 may also include a cleaning subsystem or cleaning shoe (collectively referred to as cleaning subsystem 118) that may include a cleaning fan 120, a chaffer 122, and/or a sieve 124. The material handling subsystem 125 may also include a tailings elevator 128 and/or a clean grain elevator 130, as well as an unloading auger 134 and/or a spout 136. The clean grain elevator 130 may move clean grain into a clean grain tank 132. The agricultural harvester 100 may also include a residue subsystem 138 that may include a discharge beater 126, a chopper 140 and/or a spreader 142. The agricultural harvester 100 may also include a propulsion subsystem that may include an engine that drives ground engaging components 144, such as wheels or tracks. In some examples, a combine harvester within the scope of the present disclosure may have more than one of any of the subsystems mentioned above . In some examples, the agricultural harvester 100 may have left and right cleaning sub systems, separators, etc., which are not shown in FIG. 1.

In operation, and by way of overview, the agricultural harvester 100 illustratively moves through a field in the direction indicated by arrow 147. As the agricultural harvester 100 moves, the header 102 (and an associated reel 164) may engage the crop to be harvested and gather the crop toward the cutter 104. An operator of the agricultural harvester 100 may be a local human operator, a remote human operator, and/or an automated system. An operator command is a command by an operator. The operator of the agricultural harvester 100 may determine one or more of a height setting, a tilt angle setting, and/or a roll angle setting for the header 102. For example, the operator may input a setting or settings to a control system, described in more detail below, that controls the actuator 107. The control system may also receive a setting from the operator for establishing the tilt angle and/or roll angle of the header 102 and implement the inputted settings by controlling associated actuators, not shown, that operate to change the tilt angle and/or roll angle of the header 102. The actuator 107 may maintain the header 102 at a height above the ground 111 based on a height setting and, where applicable, at desired tilt and/or roll angles. Each of the height, roll, and tilt settings may be implemented independently of the others. The control system may respond to header error (e.g., the difference between the height setting and measured height of the header 102 above the ground 111 and, in some examples, tilt angle and/or roll angle errors) with a responsiveness that is determined based on a selected sensitivity level. If the sensitivity level is set at a greater level of sensitivity, the control system may respond to smaller header position errors, and attempt to reduce the detected errors more quickly than when the sensitivity is at a lower level of sensitivity.

Returning to the description of the operation of the agricultural harvester 100, after crops are cut by cutter 104, the severed crop material may be moved through a conveyor in the feeder house 106 toward the feed accelerator 108, which accelerates the crop material into the thresher 110. The crop material may be threshed by the threshing rotor 112 rotating the crop against the concaves 114. The threshed crop material may be moved by a separator rotor in the separator 116 where a portion of the residue may be moved by the discharge beater 126 toward the residue subsystem 138. The portion of residue transferred to the residue subsystem 138 may be chopped by the chopper 140 and spread on the field by the spreader 142. In other configurations, the residue may be released from the agricultural harvester 100 in a windrow. In other examples, the residue subsystem 138 may include weed seed eliminators (not shown) such as seed baggers or other seed collectors, or seed crushers or other seed destroyers.

Grain may fall to the cleaning subsystem 118. The chaffer 122 may separate some larger pieces of material from the grain, and the sieve 124 may separate some finer pieces of material from the clean grain. The clean grain may fall to an auger that may move the grain to an inlet end of the clean grain elevator 130, and the clean grain elevator 130 may move the clean grain upwards, depositing the clean grain in the clean grain tank 132. Residue may be removed from the cleaning subsystem 118 by airflow generated by the cleaning fan 120. The cleaning fan 120 may direct air along an airflow path upwardly through the sieves and chaffers. The airflow may carry residue rearwardly in the agricultural harvester 100 toward the residue subsystem 138.

The tailings elevator 128 may return tailings to the thresher 110 where the tailings are re-threshed. Alternatively, the tailings also may be passed to a separate re-threshing mechanism by a tailings elevator or another transport device where the tailings are re-threshed as well.

FIG. 1 also shows that, in one example, the agricultural harvester 100 may include a machine speed sensor 146, one or more separator loss sensors 148, a clean grain camera 150, a forward/rearward looking image capture mechanism 151, which may be in the form of a stereo or mono camera, one or more loss sensors 152 provided in the cleaning subsystem 118, and/or at least one sideways looking image capture mechanism 153 (may also be in the form of a stereo or mono camera).

The machine speed sensor 146 may sense the travel speed of the agricultural harvester 100 over the ground 111. The machine speed sensor 146 may sense the travel speed of the agricultural harvester 100 by sensing the speed of rotation of the ground engaging components (such as wheels or tracks), a drive shaft, an axel, or other components. In some instances, the travel speed may be sensed using a positioning system, such as a global positioning system (GPS), a dead reckoning system, a long range navigation (LORAN) system, or a wide variety of other systems or sensors that provide an indication of travel speed.

The loss sensors 152 illustratively provide an output signal indicative of the quantity of grain loss occurring in both the right and left sides of the cleaning subsystem 118. In some examples, the loss sensors 152 are strike sensors which count grain strikes per unit of time or per unit of distance traveled to provide an indication of the grain loss occurring at the cleaning subsystem 118. The strike sensors for the right and left sides of the cleaning subsystem 118 may provide individual signals or a combined or aggregated signal. In some examples, the loss sensors 152 may include a single sensor as opposed to separate sensors provided for each side of the cleaning subsystem 118. The separator loss sensors 148 may provide a signal indicative of grain loss in the left and right separators, not separately shown in FIG. 1. The separator loss sensors 148 may be associated with the left and right separators and may provide separate grain loss signals or a combined or aggregate signal. In some instances, sensing grain loss in the separators may also be performed using a wide variety of different types of sensors as well.

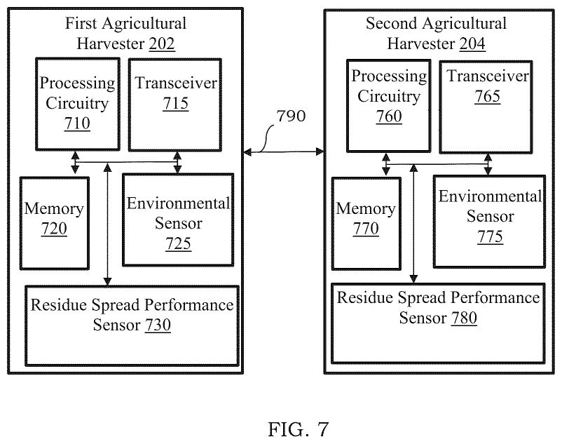

The agricultural harvester 100 may also include other sensors and measurement mechanisms. For instance, the agricultural harvester 100 may include one or more of the following sensors: a header height sensor that senses a height of the header 102 above the ground 111; stability sensors that sense oscillation or bouncing motion (and amplitude) of the agricultural harvester 100; a residue setting sensor that is configured to sense whether the agricultural harvester 100 is configured to chop the residue, produce a windrow, etc.; one or more sensors for detecting a residue spread performance of the agricultural harvester 100 or of another agricultural harvester (e.g., at least one camera, a Radar system, a Lidar system, etc.); a cleaning shoe fan speed sensor to sense the speed of the cleaning fan 120; a concave clearance sensor that senses clearance between the threshing rotor 112 and the concaves 114; a threshing rotor speed sensor that senses a rotor speed of the threshing rotor 112; a chaffer clearance sensor that senses the size of openings in the chaffer 122; a sieve clearance sensor that senses the size of openings in the sieve 124; a material other than grain (MOG) moisture sensor that senses a moisture level of the MOG passing through the agricultural harvester 100; one or more machine setting sensors configured to sense various configurable settings of the agricultural harvester 100; a machine orientation sensor that senses the orientation of the agricultural harvester 100; and/or crop property sensors that sense a variety of different types of crop properties, such as crop type, crop moisture, and/or other crop properties. Crop property sensors may also be configured to sense characteristics of the severed crop material as the crop material is being processed by the agricultural harvester 100. For example, in some instances, the crop property sensors may sense grain quality such as broken grain, MOG levels; grain constituents such as starches and protein; and/or grain feed rate as the grain travels through the feeder house 106, the clean grain elevator 130, or elsewhere in the agricultural harvester 100. The crop property sensors may also sense the feed rate of biomass through the feeder house 106, through the separator 116 or elsewhere in the agricultural harvester 100. The crop property sensors may also sense the feed rate as a mass flow rate of grain through the clean grain elevator 130 or through other portions of the agricultural harvester 100 or provide other output signals indicative of other sensed variables. According to some example embodiments, the at least one environmental sensor 725, the at least one residue spread performance sensor 730, the at least one environmental sensor 775, and/or the at least one residue spread performance sensor 780, as discussed in connection with FIG. 7, may each include one or more of the sensors discussed above as included in the agricultural harvester 100.

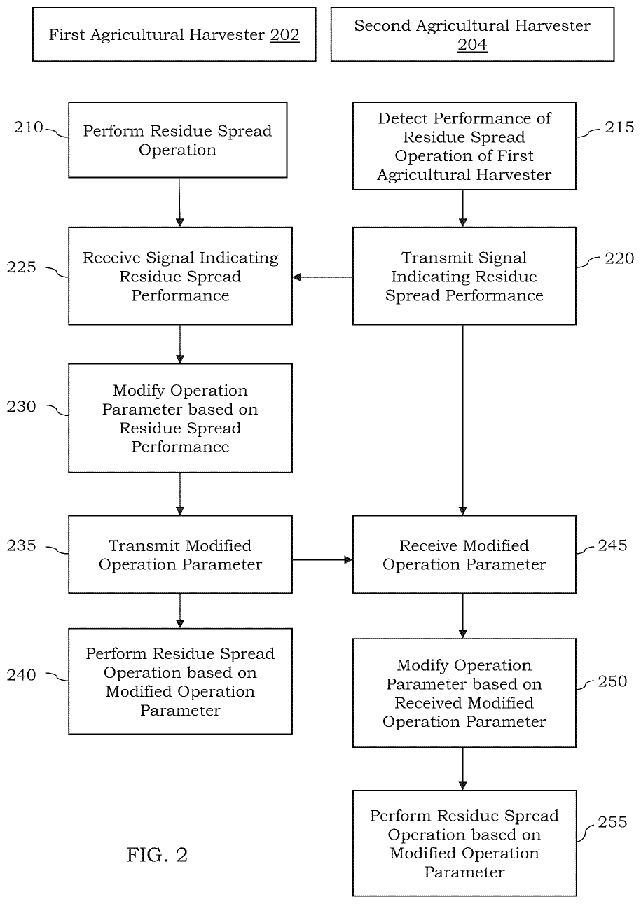

With reference to FIG. 2, a flow chart illustrates a collaborative process for detecting, and modifying an operation parameter based on, a residue spread performance, according to some example embodiments. The collaborative process is illustrated as being performed by a first agricultural harvester 202 and a second agricultural harvester 204. Each of the first agricultural harvester 202 and the second agricultural harvester 204 may be implemented by the agricultural harvester 100 discussed in connection with FIG. 1. The operations described herein as being performed by the first agricultural harvester 202 and the second agricultural harvester 204 may be performed using processing circuitry (e.g., the processing circuitry 710 and the processing circuitry 760, respectively, discussed below in connection with FIG. 7) respectively contained in the first agricultural harvester 202 and the second agricultural harvester 204 (e.g., the control system discussed above in connection with FIG. 1), but some example embodiments are not limited thereto. According to some example embodiments, at least some of the operations described herein as being performed by the first agricultural harvester 202 and the second agricultural harvester 204 may be performed using processing circuitry remote from the first agricultural harvester 202 and the second agricultural harvester 204 (e.g., an external server). The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

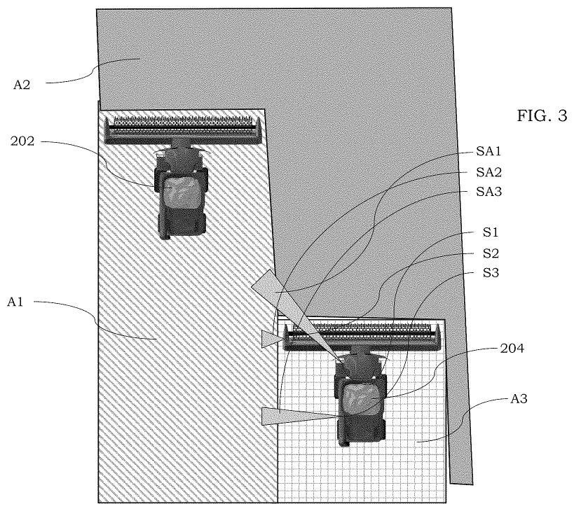

At operation 210, the first agricultural harvester 202 may perform a residue spread operation. The residue spread operation may include spreading a crop residue (e.g., MOG) behind the first agricultural harvester 202 as the first agricultural harvester 202 cuts a crop in front of the first agricultural harvester 202. As an example, with reference to FIG. 3 illustrating a residue spread operation performed by the first agricultural harvester 202 and the second agricultural harvester 204, according to some example embodiments, the residue spread operation may include spreading the residue to both edges of a cut in a first harvesting area A1. The edges of the cut in the first harvesting area A1 may correspond to a width of the header 102 of the first agricultural harvester 202. According to some example embodiments, the residue spread operation may include spreading the residue to form a windrow. As may be generally understood, examples provided in this disclosure in the context of a residue spread operation including spreading the residue to both edges of the cut may also be applied to a residue spread operation including forming the windrow. A width of the residue spread may vary in either direction in response to the effects of environmental conditions including, for example, a wind (e.g., wind strength, wind direction/cross wind, etc.), a terrain (e.g., side slope, pitch, etc.), a feedrate (e.g., varying according to a speed of the first agricultural harvester 202, a height of the header 102, a type of crop in the first harvesting area A1), and/or a moisture of the crop.

Referring to FIGS. 2 and 3, at operation 215, the second agricultural harvester 204 may sense a performance of the residue spread operation performed by the first agricultural harvester 202. The second agricultural harvester 204 may perform operation 215 contemporaneous with the performance of operation 210 by the first agricultural harvester 202. The second agricultural harvester 204 may be geo-physically positioned within a first threshold distance of the first agricultural harvester 202 (or of the residue spread by the first agricultural harvester 202, for instance, a residue spread location) sufficient to enable sensing of the residue spread performance, and outside of a second threshold distance sufficient to eliminate or sufficiently reduce the hinderance of the sensing by the cloud of dust and debris following the first agricultural harvester 202. According to some example embodiments, the first threshold distance and the second threshold distance may be design parameters determined through empirical study. According to some example embodiments, the second agricultural harvester 204 may perform operation 215 while being geo-physically positioned in a different harvesting row (e.g., an adjacent row to that being harvester by the first agricultural harvester 202), for example, in a third harvesting area A3. According to some example embodiments, the second agricultural harvester 204 may perform operation 215 while traveling in the same direction as, or a different direction from (e.g., an opposite direction), that being traveled by the first agricultural harvester 202 while performing operation 210. According to some example embodiments, the second agricultural harvester 204 may perform operation 215 without traveling.

According to some example embodiments, the second agricultural harvester 204 may detect the residue spread performance of the first agricultural harvester 202 using one or more sensors (e.g., sensors S1, S2 and/or S3, may collectively correspond to the at least one residue spread performance sensor 780) on the second agricultural harvester 204. According to some example embodiments, the residue spread performance may include one or more parameters including a width of the spread on one or both sides, a uniformity of the spread, a spread distribution, a distance of the spread from a cut edge of the row on one or both sides, a size (e.g., MOG particle size) of the residue, etc. According to some example embodiments, in situations in which the residue spread operation includes forming the windrow, the residue spread performance may include a size (e.g., a height, a volume, etc.) and/or dimension (e.g., a width) of the windrow in place of the distance of the spread from the cut edge of the row on one or both sides. The one or more sensors may include, for example, at least one camera, a Radar system, a Lidar system, etc. According to some example embodiments, the at least one camera may detect visible light (e.g., red, green and blue light), infrared light (e.g., thermal imaging), etc. According to some example embodiments, the one or more sensors may be forward-looking and positioned on a front end of the second agricultural harvester 204 (e.g., a first sensor S1). According to some example embodiments, the one or more sensors may be sideways-looking and positioned on a side of the second agricultural harvester 204 (e.g., a second sensor S2 and a third sensor S3). According to some example embodiments, the first sensor S1 may be implemented by the forward looking image capture mechanism 151, and each of the second sensor S2 and the third sensor S3 may be implemented using the at least one sideways looking image capture mechanism 153). According to some example embodiments, each of the one or more sensors may have a corresponding sensing area. For example, the first sensor S1 may have a first sensing area SA1, the second sensor S2 may have a second sensing area SA2, and the third sensor S3 may have a third sensing area SA3. According to some example embodiments, the one or more sensors may include both at least one forward-looking sensor and at least one sideways-looking sensor (e.g., the first sensor S1, the second sensor S2 and the third sensor S3). According to some example embodiments, the one or more sensors may detect the residue spread of the first agricultural harvester 202 (e.g., a width of the spread on one or both sides, a uniformity of the spread, a spread distribution, a distance of the spread from a cut edge of the row on one or both sides, a size (e.g., MOG particle size) of the residue, a size (e.g., a height, a volume, etc.) and/or dimension (e.g., a width) of the windrow, etc.) based on the residue spread on the ground and/or based on the residue spread in the air.

In operation 220, the second agricultural harvester 204 may transmit a first signal indicating the detected (e.g., sensed) residue spread performance to the first agricultural harvester 202. According to some example embodiments, the second agricultural harvester 204 may include a transceiver (e.g., the transceiver 765 discussed below in connection with FIG. 7), or a transmitter and receiver, as well as corresponding communication processing circuitry (e.g., may refer collectively to the transceiver 765 discussed below in connection with FIG. 7), for use in transmitting and/or receiving communication signals to other devices (e.g., the first agricultural harvester 202, another agricultural harvester 100, etc.). According to some example embodiments, the first signal indicating the sensed residue spread performance may be transmitted via any suitable type of communication link (e.g., the communication link 790 discussed below in connection with FIG. 7). For example, the communication link may be an Ethernet link, an 802.11 (WiFi) link, a Radio Frequency (RF) (e.g., cellular) link, a Transmission Control Protocol/Internet Protocol (TCP/IP) link, a Universal Serial Bus (USB) link, a Bluetooth™ link, or any combination thereof.

According to some example embodiments, the second agricultural harvester 204 may detect a geo-location at a residue spread location. According to some example embodiments, the residue spread location may correspond to the geo-location of the first agricultural harvester 202 at a time at which the second agricultural harvester 204 senses the residue spread performance of the first agricultural harvester 202 (e.g., in circumstances in which the second agricultural harvester 204 senses the residue spread performance, by sensing residue in the air for instance, as the first agricultural harvester 202 performs the residue spread operation). According to some example embodiments, the residue spread location may correspond to geo-location at which the first agricultural harvester 202 spreads the sensed residue (e.g., a geo-location of the residue associated with the residue spread performance, by sensing residue on the ground for instance). For example, the second agricultural harvester 204 may include a GPS receiver. According to some example embodiments, the second agricultural harvester 204 may determine its geo-position using the GPS receiver, and detect the residue spread location based on a relative positioning of the first agricultural harvester 202 with respect to the second agricultural harvester 204. For example, the second agricultural harvester 204 may determine the relative positioning of the first agricultural harvester 202 with respect to the second agricultural harvester 204 using the one or more sensors discussed above (e.g., at least one camera, a Radar system, a Lidar system, etc.), based on communication signals transmitted between the first agricultural harvester 202 and the second agricultural harvester 204 (e.g., based on a time of flight computed based on, for instance, a beacon signal transmitted by the first agricultural harvester 202 and/or a response signal transmitted by the first agricultural harvester 202 in response to a ping signal transmitted by the second agricultural harvester 204), etc. According to some example embodiments, the second agricultural harvester 204 may determine the relative positioning of the first agricultural harvester 202 with respect to the second agricultural harvester 204 taking into consideration a distance between the GPS receiver and the one or more sensors, and/or transceiver, of the second agricultural harvester 204. According to some example embodiments, the second agricultural harvester 204 may determine the relative positioning of the first agricultural harvester 202 with respect to the second agricultural harvester 204 based on at least one sensed area (e.g., the first sensed area SA1, the second sensed area SA2 and/or the third sensed area SA3) in which the first agricultural harvester 202 is detected, and a respective distance between a corresponding sensor (e.g., the first sensor S1, the second sensor S2 and/or third sensor S3) and the GPS receiver (may also take into consideration an angle formed by (1) the distance between the corresponding sensor and the first agricultural harvester 202 and (2) the distance between the corresponding sensor and the GPS receiver).

In operation 225, the first agricultural harvester 202 may receive the first signal indicating the detected (e.g., sensed) residue spread performance from the second agricultural harvester 204. According to some example embodiments, the first agricultural harvester 202 may include a transceiver (e.g., the transceiver 715 discussed below in connection with FIG. 7), or a transmitter and receiver, as well as corresponding communication processing circuitry (e.g., may refer collectively to the transceiver 715 discussed below in connection with FIG. 7), for use in transmitting and/or receiving communication signals to other devices (e.g., the second agricultural harvester 204, another agricultural harvester 100, etc.). According to some example embodiments, the received first signal may include the residue spread performance and the geo-location of the residue spread location. The first agricultural harvester 202 may obtain the residue spread performance, or both the residue spread performance and the geo-location of the residue spread location, from the received first signal.

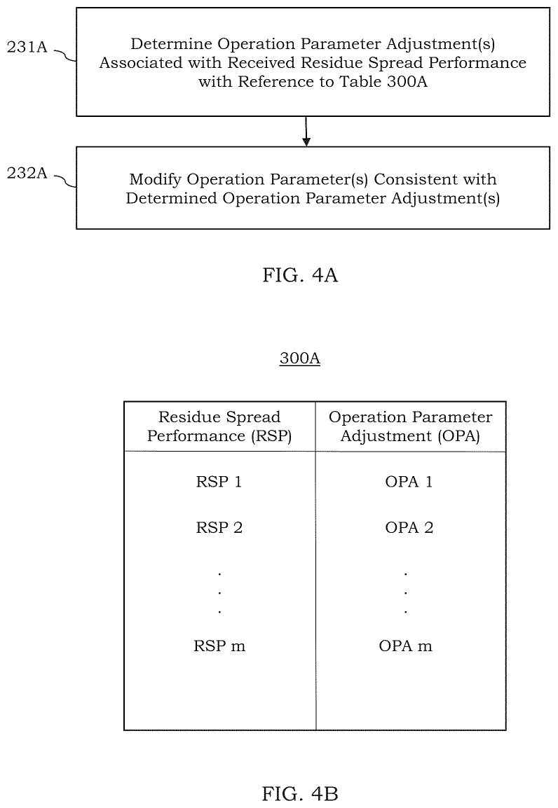

In operation 230, the first agricultural harvester 202 may modify at least one first operation parameter (also referred to herein as the first operation parameter(s)) of the first agricultural harvester 202 based on the residue spread performance (discussed further in connection with FIGS. 4A and 4B below). According to some example embodiments, the first operation parameter(s) may include one or more of a speed of the spreader 142, a shroud/vane angle of the spreader 142, a speed of the chopper 140, a counter knife position of the chopper 140, a feedrate of the first agricultural harvester 202 (e.g., by modifying a travel speed of the first agricultural harvester 202, a height of the header 102, etc.), a concave clearance of the threshing rotor 112, and/or a speed of the threshing rotor 112. Through modification of the first operation parameter(s), the first agricultural harvester 202 may control a further residue spread operation (e.g., in a second harvesting area A2) to spread residue in a different direction, a different distance, etc., and thus, may control a spread width of the residue, a uniformity of the spread residue, etc., to improve the residue spread performance of the first agricultural harvester 202.

According to some example embodiments, the first agricultural harvester 202 may modify the first operation parameter(s) based on the residue spread performance with reference to a table. The table may store associations between respective residue spread performance values and corresponding operation parameter adjustments. Accordingly, for any given residue spread performance the first agricultural harvester 202 may identify one or more associated operation parameter adjustments, and modify the first operation parameter(s) consistent with the identified one or more operation parameter adjustments.

According to some example embodiments, the information contained in the table may be previously generated (e.g., by an expert user, manufacturer, etc.). According to some example embodiments, the information in the table may be generated and/or adjusted by the first agricultural harvester 202. For example, the first agricultural harvester 202 may train a machine learning model using reference training data. The reference training data may include, for example, reference residue spread performance values and corresponding reference operation parameter adjustments. The reference operation parameter adjustments may include adjustments to one or more operation parameters sufficient to correct the corresponding reference residue spread performance values to within a threshold level of residue spread performance. The first agricultural harvester 202 may train the machine learning model until the machine learning model outputs one or more operation parameters, in response to input of a corresponding residue spread performance, that corrects the corresponding residue spread performance to within the threshold level of residue spread performance at a threshold level of consistency. According to some example embodiments, the threshold level of residue spread performance and/or the threshold level of reliability may be design parameters determined through empirical study.

According to some example embodiments, the first agricultural harvester 202 may update the trained machine learning model based on current settings of one or more operation parameters and the residue spread performance received from the second agricultural harvester 204. According to some example embodiments, the machine learning model may be initially trained by a different device from the first agricultural harvester 202 (e.g., by an external server), received by the first agricultural harvester 202, and subsequently updated according to residue spread performances received during operation.

In some example embodiments, the machine learning model may be implemented as an artificial neural network that is trained on a set of training data by, for example, a supervised, unsupervised, and/or reinforcement learning model, and wherein the processing circuitry of the first agricultural harvester 202 (e.g., the processing circuitry 710) may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry of the first agricultural harvester 202 (e.g., the processing circuitry 710) may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

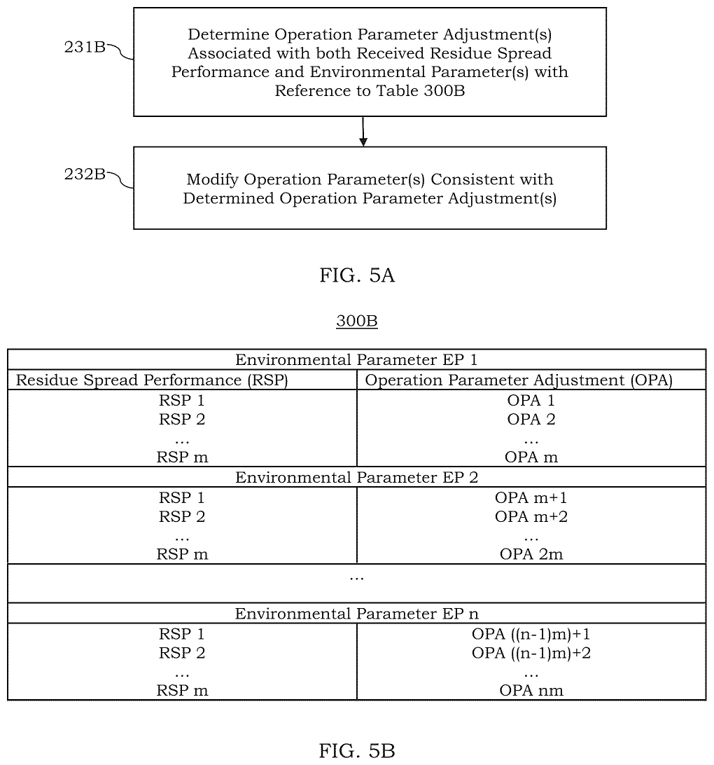

According to some example embodiments, the first agricultural harvester 202 may modify the first operation parameter(s) based on the residue spread performance and at least one environmental parameter (also referred to herein as an environmental parameter(s)). For example, the table may store associations between respective residue spread performance values, corresponding operation parameter adjustments and corresponding environmental parameters (discussed further in connection with FIGS. 5A and 5B below). According to some example embodiments, the first agricultural harvester 202 may include at least one environmental sensor (e.g., the at least one environmental sensor 725 discussed in connection with FIG. 7 below) to sense the environmental parameter(s), for instance, the environmental parameter(s) may include one or more of a wind speed and/or direction at the first agricultural harvester 202, a terrain slope and/or pitch at the geo-location of the first agricultural harvester 202, a feedrate of the first agricultural harvester 202, and/or a moisture amount of a crop being processed by the first agricultural harvester 202, but some example embodiments are not limited thereto. According to some example embodiments, the at least one environmental sensor may be remote from the first agricultural harvester 202 (e.g., at an external server providing a weather service). According to some example embodiments, the reference data used to train the machine learning model may include, for instance, reference residue spread performance values, reference environmental parameters, and corresponding reference operation parameter adjustments. The reference operation parameter adjustments may include adjustments to one or more operation parameters sufficient to correct the corresponding reference residue spread performance values to within the threshold level of residue spread performance under conditions reflected by the reference environmental parameter(s).

According to some example embodiments, in situations in which the first operation parameter(s) are modified based on the residue spread performance and the environmental parameter(s), the first agricultural harvester 202 may update the trained machine learning model based on current settings of one or more operation parameters, the residue spread performance received from the second agricultural harvester 204 and the environmental parameter(s) measured/sensed by the first agricultural harvester 202. According to some example embodiments, the machine learning model may be initially trained by a different device from the first agricultural harvester 202 (e.g., by an external server), received by the first agricultural harvester 202, and subsequently updated according to residue spread performances and received, and environmental parameters measured/sensed, during operation.

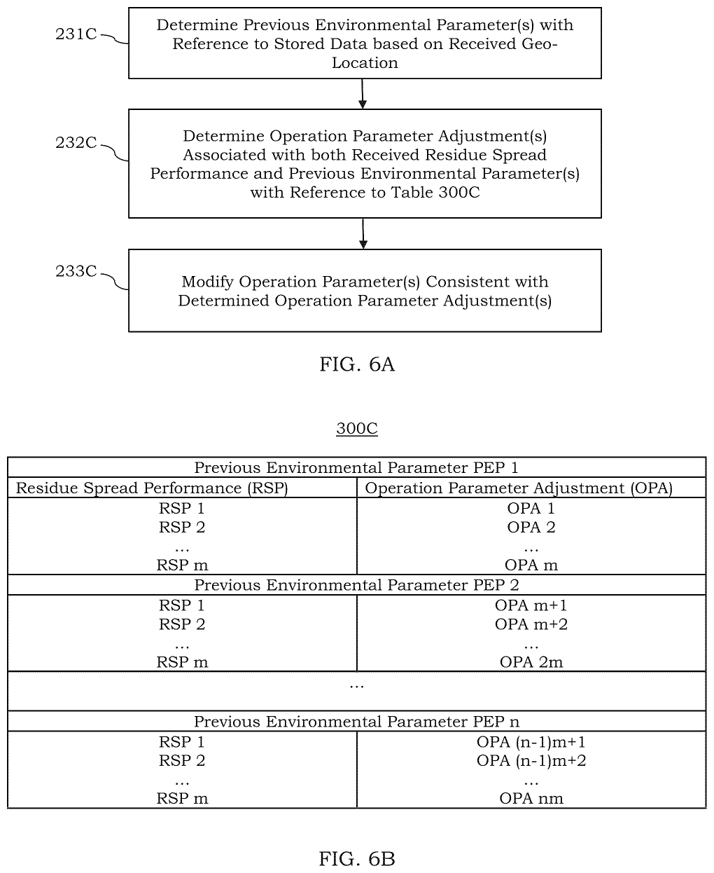

According to some example embodiments, the first agricultural harvester 202 may modify the first operation parameter(s) based on the residue spread performance and a previous environmental parameter(s) measured at the residue spread location (discussed further in connection with FIGS. 6A and 6B below). According to some example embodiments, the first agricultural harvester 202 may include a memory (e.g., the memory 720 discussed below in connection with FIG. 7), and may store environmental parameters detected by the at least one environmental sensor (e.g., the at least one environmental sensor 725) in correspondence with geo-locations at which the environmental parameters were detected. According to some example embodiments, each respective geo-location among the geo-locations at which the environmental parameters were detected may be stored in the memory in association with a corresponding time at which the first agricultural harvester 202 was positioned at the respective geo-location. As discussed above, the table may store associations between respective residue spread performance values, corresponding operation parameter adjustments and corresponding environmental parameters. The first agricultural harvester 202 may determine a previous environmental parameter(s) measured at the residue spread location obtained from the first signal received from the second agricultural harvester 204 with reference to the information stored in the memory (e.g., the memory 720). The first agricultural harvester 202 may determine an operation parameter adjustment(s) with reference to the table based on the determined previous environmental parameter(s) and the residue spread performance. The first agricultural harvester 202 may modify the first operation parameter(s) consistent with the determined operation parameter adjustment(s).

According to some example embodiments, in situations in which the first operation parameter(s) are modified based on the residue spread performance and the previous environmental parameter(s), the first agricultural harvester 202 may update the trained machine learning model based on current settings of one or more operation parameters, the residue spread performance received from the second agricultural harvester 204 and the previous environmental parameter(s) measured/sensed by the first agricultural harvester 202 at the residue spread location. According to some example embodiments, the machine learning model may be initially trained by a different device from the first agricultural harvester 202 (e.g., by an external server), received by the first agricultural harvester 202, and subsequently updated according to residue spread performances and received, and previous environmental parameters measured/sensed, during operation.

According to some example embodiments, the first agricultural harvester 202 may generate a map based on the received residue spread location, determined previous environmental parameter(s), residue spread performance, and/or operation parameter(s) active when the first agricultural harvester 202 was at the residue spread location. For example, the first agricultural harvester 202 may update the map with information corresponding to each new first signal received from another agricultural harvester 100 (e.g., the second agricultural harvester 204) indicating a residue spread performance and residue spread location in a field. The map may be used by other devices subsequently operating in the field (e.g., tillage equipment).

At operation 235, the first agricultural harvester 202 may transmit a second signal indicating the modified first operation parameter(s) to the second agricultural harvester 204 (e.g., via the communication link 790). According to some example embodiments, the second signal may indicate the modified first operation parameter(s) and one or more machine parameters of the first agricultural harvester 202. For example, the one or more machine parameters may include a header width of the first agricultural harvester 202, a residue spread configuration (e.g., at least one setting of the chopper 140, the spreader 142, etc.) of the first agricultural harvester 202, a height of the header 102 of the first agricultural harvester 202, and/or a speed of travel of the first agricultural harvester 202. Contemporaneously with, or subsequent to, performance of operation 235, the first agricultural harvester 202 may perform a residue spread operation in a second harvesting area A2 using the modified first operation parameter(s) at operation 240. According to some example embodiments, the second harvesting area A2 may be in a same row as, or a different row from, the first harvesting area A1.

At operation 245, the second agricultural harvester 204 may receive the second signal (e.g., via the communication link 790) and obtain the modified first operation parameter(s) from the second signal. At operation 250, the second agricultural harvester 204 may modify a second operation parameter(s) of the second agricultural harvester 204 based on the modified first operation parameter(s) received from the first agricultural harvester 202. According to some example embodiments, the second operation parameter(s) may be the same as, or similar to, the first operation parameter(s), and the second agricultural harvester 204 may modify the second operation parameter(s) to be consistent with the modified first operation parameter(s). At operation 255, the second agricultural harvester 204 may perform a residue spread operation using the modified second operation parameter(s).

According to some example embodiments, the second agricultural harvester 204 may obtain both the modified first operation parameter(s) and the one or more machine parameters from the second signal. The second agricultural harvester 204 may adjust the modified first operation parameter(s) according to the one or more machine parameters. For example, the second agricultural harvester 204 may be of a different type than, or have a different type of operation parameter(s) from, the first agricultural harvester 202. Accordingly, the second agricultural harvester 204 may adjust the modified first operation parameter(s) by converting the modified first operation parameter(s) according to a form corresponding to the second agricultural harvester 204 (e.g., based on conversion information stored in a memory 770 of the second agricultural harvester 204). At operation 250, the second agricultural harvester 204 may modify the second operation parameter(s) of the second agricultural harvester 204 based on the adjusted modified first operation parameter(s). According to some example embodiments, the second agricultural harvester 204 may modify the second operation parameter(s) to be consistent with the adjusted modified first operation parameter(s). At operation 255, the second agricultural harvester 204 may perform a residue spread operation using the modified second operation parameter(s).

According to some example embodiments, operation 250 may further include adjusting the second operation parameter(s) of the second agricultural harvester 204 based on an environmental condition(s) sensed at the second agricultural harvester 204 (e.g., by the at least one environmental sensor 775), for example, a wind (e.g., wind strength, wind direction/cross wind, etc.), a terrain (e.g., side slope, pitch, etc.), a feedrate (e.g., varying according to a speed of the second agricultural harvester 204, a height of the header 102, a type of crop in the harvesting area of the second agricultural harvester 204), and/or a moisture of the crop. According to some example embodiments, the at least one environmental sensor 775 may be included on the second agricultural harvester 204, but some example embodiments are not limited thereto. According to some example embodiments, the at least one environmental sensor 775 may be remote from the second agricultural harvester 204 (e.g., at the external server providing the weather service). According to some example embodiments, the second agricultural harvester 204 may adjust the modified second operation parameter(s) based on the environmental condition(s) according to, for example, an adjustment amount stored in association with a corresponding value(s) of the environmental condition(s) (e.g., in the memory 770).

According to some example embodiments, the first agricultural harvester 202 and the second agricultural harvester 204 may be representative of roles that may be performed by any of a plurality of agricultural harvesters 100. For example, in a scenario in which a plurality of agricultural harvesters 100 are operating together in a field, each respective agricultural harvester 100 may operate both as the first agricultural harvester 202 with respect to at least one other agricultural harvester 100 (e.g., the second agricultural harvester 204) and as the second agricultural harvester 204 with response to at least one other agricultural harvester 100 (e.g., the first agricultural harvester 202). In this example scenario, each of the agricultural harvesters 100 includes all of the hardware, and is configured to perform all of the operations, discussed above in connection both the first agricultural harvester 202 and the second agricultural harvester 204. According to some example embodiments, the operations discussed in connection with FIG. 2 (e.g., the sensing of the residue spread performance and adjustment of the operation parameter(s)) may be performed in real-time.

With reference to FIGS. 4A and 4B, a flow chart and corresponding table 300A are illustrated for explanation of operation 230 in which an operation parameter adjustment(s) is determined based on a received residue spread performance according to some example embodiments.

In operation 231A, the first agricultural harvester 202 may determine an operation parameter adjustment(s) associated in a table 300A with the residue spread performance received from the second agricultural harvester 204 in operation 225. With reference to FIG. 4B, the table 300A may store a plurality of operation parameter adjustments OPA 1, OPA 2, . . . OPA m in association with corresponding residue spread performance values RSP 1, RSP 2, . . . RSP m (where m is an integer having a value of 3 or more). Each of the parameter adjustments OPA 1, OPA 2, . . . OPA m may be associated with an adjustment to one or more first operation parameters of the first agricultural harvester 202. Each of the residue spread performance values RSP 1, RSP 2, . . . RSP m may be associated with a value of one or more residue spread performance parameters (see, e.g., the discussion of residue spread performance parameters in connection with operation 215 above). According to some example embodiments, the degree of granularity of the information contained in the table 300A may be a design parameter determined through empirical study. According to some example embodiments, each of the parameter adjustments OPA 1, OPA 2, . . . , OPA m may be associated with only one of the corresponding residue spread performance values RSP 1, RSP 2, . . . RSP m. According to some example embodiments, each of the parameter adjustments OPA 1, OPA 2, . . . , OPA m may be associated with one or more of the corresponding residue spread performance values RSP 1, RSP 2, . . . RSP m. According to some example embodiments, the table 300A may include only the parameter adjustments OPA 1, OPA 2, . . . , OPA m and the corresponding residue spread performance values RSP 1, RSP 2, . . . RSP m, but some example embodiments are not limited thereto.

Referring to FIG. 4A, in operation 232A, the first agricultural harvester 202 may modify a first operation parameter(s) of the first agricultural harvester 202 consistent with the operation parameter adjustment(s) determined in operation 231A.

With reference to FIGS. 5A and 5B, a flow chart and corresponding table 300B are illustrated for explanation of operation 230 in which an operation parameter adjustment(s) is determined based on both a received residue spread performance and an environmental parameter(s), according to some example embodiments.

In operation 231B, the first agricultural harvester 202 may determine an operation parameter adjustment(s) associated in a table 300B with both (1) the residue spread performance received from the second agricultural harvester 204 in operation 225 and (2) an environmental parameter(s) sensed at the first agricultural harvester 202. With reference to FIG. 5B, the table 300B may store a plurality of operation parameter adjustments (OPA 1, OPA 2, . . . OPA m (where m is an integer having a value of 3 or more), OPA m+1, OPA m+2 . . . OPA 2m, OPA ((n−1)m)+1, OPA ((n−1)m)+2 . . . OPA nm (where n is an integer having a value of 3 or more, and may be equal to or different from m)) in association with both (1) corresponding residue spread performance values (RSP 1, RSP 2, . . . RSP m), and (2) corresponding environmental parameters (EP 1, EP 2 . . . EP n). Each of the parameter adjustments may be associated with an adjustment to one or more first operation parameters of the first agricultural harvester 202. Each of the residue spread performance values may be associated with a value of one or more residue spread performance parameters (see, e.g., the discussion of residue spread performance parameters in connection with operation 215 above). Each of the environmental parameters may be associated with a value of one or more of the environmental parameter(s) discussed above in connection with operation 230. According to some example embodiments, the degree of granularity of the information contained in the table 300B may be a design parameter determined through empirical study. According to some example embodiments, each of the parameter adjustments may be associated with only one of the corresponding residue spread performance values and/or environmental parameters. According to some example embodiments, each of the parameter adjustments may be associated with one or more of the corresponding residue spread performance values and/or environmental parameters. According to some example embodiments, the table 300B may include only the parameter adjustments, the corresponding residue spread performance values and the environmental parameters, but some example embodiments are not limited thereto.

Referring to FIG. 5A, in operation 232B, the first agricultural harvester 202 may modify a first operation parameter(s) of the first agricultural harvester 202 consistent with the operation parameter adjustment(s) determined in operation 231B.

With reference to FIGS. 6A and 6B, a flow chart and corresponding table 300C are illustrated for explanation of operation 230 in which an operation parameter adjustment(s) is determined based on both a received residue spread performance and a previous environmental parameter(s), according to some example embodiments.

In operation 231C, the first agricultural harvester 202 may determine a previous environmental parameter(s) measured at the residue spread location obtained from the first signal received from the second agricultural harvester 204 with reference to the information stored in the memory. According to some example embodiments, the first agricultural harvester 202 may store environmental parameters detected by the at least one environmental sensor (e.g., the at least one environmental sensor 725), in a memory of the first agricultural harvester 202 (e.g., the memory 720), in correspondence with geo-locations at which the environmental parameters were detected. The first agricultural harvester 202 may determine the previous environmental parameter(s) as that associated with a geo-location of the residue spread location in the memory.

In operation 232C, the first agricultural harvester 202 may determine an operation parameter adjustment(s) associated in a table 300C with both (1) the residue spread performance received from the second agricultural harvester 204 in operation 225 and (2) the determined previous environmental parameter(s). With reference to FIG. 6B, the table 300C may store a plurality of operation parameter adjustments (OPA 1, OPA 2, . . . OPA m (where m is an integer having a value of 3 or more), OPA m+1, OPA m+2 . . . OPA 2m, OPA ((n−1)m)+1, OPA ((n−1)m)+2 . . . OPA nm (where n is an integer having a value of 3 or more, and may be equal to or different from m)) in association with both (1) corresponding residue spread performance values (RSP 1, RSP 2, . . . RSP m), and (2) corresponding previous environmental parameters (PEP 1, PEP 2 . . . PEP n). Each of the parameter adjustments may be associated with an adjustment to one or more first operation parameters of the first agricultural harvester 202. Each of the residue spread performance values may be associated with a value of one or more residue spread performance parameters (see, e.g., the discussion of residue spread performance parameters in connection with operation 215 above). Each of the previous environmental parameters may be associated with a value of one or more of the environmental parameter(s) discussed above in connection with operation 230. According to some example embodiments, the degree of granularity of the information contained in the table 300C may be a design parameter determined through empirical study. According to some example embodiments, each of the parameter adjustments may be associated with only one of the corresponding residue spread performance values and/or previous environmental parameters. According to some example embodiments, each of the parameter adjustments may be associated with one or more of the corresponding residue spread performance values and/or previous environmental parameters. According to some example embodiments, the table 300C may include only the parameter adjustments, the corresponding residue spread performance values and the previous environmental parameters, but some example embodiments are not limited thereto.

Referring to FIG. 6A, in operation 233C, the first agricultural harvester 202 may modify a first operation parameter(s) of the first agricultural harvester 202 consistent with the operation parameter adjustment(s) determined in operation 232C.

FIG. 7 is a diagram of a system for detecting, and modifying an operation parameter based on, a residue spread performance, according to some example embodiments. The system may include the first agricultural harvester 202 and the second agricultural harvester 204, but some example embodiments are not limited thereto. According to some example embodiments, the system may include three or more agricultural harvesters 100, each of which is capable of performing operations consistent with those of the first agricultural harvester 202 and the second agricultural harvester 204, for example, at different times (or simultaneously or contemporaneously) and/or in collaboration with different agricultural harvesters 100 (or the same agricultural harvester 100). The first agricultural harvester 202 may include processing circuitry 710, a transceiver 715, a memory 720, at least one environmental sensor 725, and/or at least one residue spread performance sensor 730. The second agricultural harvester 204 may include processing circuitry 760, a transceiver 765, a memory 770, at least one environmental sensor 775, and/or at least one residue spread performance sensor 780. The first agricultural harvester 202 may connect to the second agricultural harvester 204 via a communication link 790 (and may connect to another agricultural harvester 100 via another, similar communication link). Likewise, the second agricultural harvester 204 may connect to the first agricultural harvester 202 via the communication link 790 (and may connect to another agricultural harvester 100 via another, similar communication link). According to some example embodiments, an intervening device (e.g., a cellular base station, access point, telecommunications network, etc.) may relay communication signals sent between the first agricultural harvester 202 and the second agricultural harvester 204. According to some example embodiments, operations described herein as being performed by the agricultural harvester 100, the first agricultural harvester 202 and/or the second agricultural harvester may be performed by processing circuitry (e.g., the processing circuitry 710 and the processing circuitry 760). According to some example embodiments, the transceiver 715, the at least one environmental sensor 725, and the at least one residue spread performance sensor 730 may operate under the control of the processing circuitry 710, and the transceiver 765, the at least one environmental sensor 775, and the at least one residue spread performance sensor 780 may operate under the control of the processing circuitry 760.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 720 and the memory 770).

According to some example embodiments, the memory 720 and the memory 770 may each be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components (or parameters, values, etc.), the components (or parameters, values, etc.) are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

1. An agricultural harvester, comprising:
processing circuitry configured to cause the agricultural harvester to,
receive a first signal from another agricultural harvester, the first signal indicating a residue spread performance, the residue spread performance corresponding to a residue spread of the agricultural harvester in a first harvesting area,
modify an operation parameter of the agricultural harvester based on the residue spread performance to obtain a modified operation parameter, and
control a residue spread of the agricultural harvester in a second harvesting area according to the modified operation parameter.

2. The agricultural harvester of claim 1, wherein the processing circuitry is configured to cause the agricultural harvester to transmit a second signal to the other agricultural harvester, the second signal indicating the modified operation parameter.

3. The agricultural harvester of claim 1, wherein the processing circuitry is configured to cause the agricultural harvester to modify the operation parameter of the agricultural harvester based on the residue spread performance and an environmental condition.

4. The agricultural harvester of claim 1, wherein the first signal indicates the residue spread performance and a first geo-location, the first geo-location corresponding to a geo-location of the residue spread of the agricultural harvester in the first harvesting area, and
wherein the processing circuitry is configured to cause the agricultural harvester to modify the operation parameter of the agricultural harvester based on the residue spread performance and the first geo-location.

5. The agricultural harvester of claim 4, wherein the processing circuitry is configured to:
cause the agricultural harvester to determine an environmental parameter corresponding to the first geo-location; and
modify the operation parameter of the agricultural harvester further based on the environmental parameter.

6. The agricultural harvester of claim 1, wherein the agricultural harvester is a first agricultural harvester, the other agricultural harvester is a second agricultural harvester, the residue spread performance is a first residue spread performance, and the modified operation parameter is a first modified operation parameter, and
wherein the processing circuitry is configured to cause the first agricultural harvester to:
detect a second residue spread performance corresponding to a residue spread of a third agricultural harvester,
transmit a third signal to the third agricultural harvester, the third signal indicating the second residue spread performance,
receive a fourth signal from the third agricultural harvester in response to the third signal, the fourth signal indicating a second modified operation parameter, and
control the residue spread of the first agricultural harvester in a third harvesting area according to the second modified operation parameter.

7. The agricultural harvester of claim 6, wherein the third agricultural harvester is the same as the second agricultural harvester.

8. An agricultural harvester, comprising:
processing circuitry configured to cause the agricultural harvester to,
detect a residue spread performance corresponding to a residue spread of another agricultural harvester,
transmit a first signal to the other agricultural harvester, the first signal indicating the residue spread performance,
receive a second signal from the other agricultural harvester in response to the first signal, the second signal indicating a modified operation parameter, and
control a residue spread of the agricultural harvester in a first harvesting area according to the modified operation parameter.

9. The agricultural harvester of claim 8, wherein the processing circuitry is configured to cause the agricultural harvester to:
determine a first geo-location of the residue spread of the other agricultural harvester; and
generate the first signal as indicating the residue spread performance at the first geo-location.

10. The agricultural harvester of claim 8, wherein the processing circuitry is configured to cause the agricultural harvester to:
adjust the modified operation parameter based on an environmental condition or a machine parameter to obtain an adjusted operation parameter; and
control the residue spread of the agricultural harvester according to the adjusted operation parameter.

11. The agricultural harvester of claim 8, wherein the agricultural harvester is a first agricultural harvester, the other agricultural harvester is a second agricultural harvester, the residue spread performance is a first residue spread performance, the modified operation parameter is a first modified operation parameter, and the first modified operation parameter corresponds to at least one operation parameter of the first agricultural harvester, and
wherein the processing circuitry is configured to cause the first agricultural harvester to:
receive a third signal from a third agricultural harvester, the third signal indicating a second residue spread performance, the second residue spread performance corresponding to a residue spread of the first agricultural harvester in a second harvesting area,
modify an operation parameter among the at least one operation parameter of the first agricultural harvester based on the second residue spread performance to obtain a second modified operation parameter, and
control the residue spread of the first agricultural harvester in a third harvesting area according to the second modified operation parameter.

12. The agricultural harvester of claim 11, wherein the processing circuitry is configured to cause the first agricultural harvester to transmit a fourth signal to the third agricultural harvester, the fourth signal indicating the second modified operation parameter.

13. The agricultural harvester of claim 11, wherein the third agricultural harvester is the same as the second agricultural harvester.

14. A system, comprising:
a first agricultural harvester configured to,
detect a residue spread performance corresponding to a residue spread of a second agricultural harvester in a first harvesting area, and
transmit a first signal to the second agricultural harvester, the first signal indicating the residue spread performance; and
the second agricultural harvester configured to,
modify an operation parameter of the second agricultural harvester based on the residue spread performance to obtain a modified operation parameter, and
control a residue spread of the second agricultural harvester in a second harvesting area according to the modified operation parameter.

15. The system of claim 14, wherein the second agricultural harvester is configured to transmit a second signal to the first agricultural harvester, the second signal indicating the modified operation parameter, and
wherein the first agricultural harvester is configured to control a residue spread of the first agricultural harvester in a third harvesting area according to the modified operation parameter.

16. The system of claim 15, wherein the first agricultural harvester is configured to:
adjust the modified operation parameter based on an environmental condition or a machine parameter to obtain an adjusted operation parameter; and
control the residue spread of the first agricultural harvester according to the adjusted operation parameter.

17. The system of claim 14, wherein the second agricultural harvester is configured to modify the operation parameter of the second agricultural harvester based on the residue spread performance and an environmental condition to obtain a modified operation parameter.

18. The system of claim 14, wherein the first agricultural harvester is configured to determine a first geo-location of the residue spread of the second agricultural harvester in the first harvesting area, the first signal indicating the residue spread performance and the first geo-location, and
wherein the second agricultural harvester is configured to modify the operation parameter of the second agricultural harvester based on the residue spread performance and the first geo-location.

19. The system of claim 18, wherein the second agricultural harvester is configured to:
determine an environmental parameter corresponding to the first geo-location; and
modify the operation parameter of the second agricultural harvester further based on the environmental parameter.

20. The system of claim 14, wherein
the residue spread performance is a first residue spread performance, and the modified operation parameter is a first modified operation parameter,
the first agricultural harvester is configured to:
receive a third signal from a third agricultural harvester, the third signal indicating a second residue spread performance, the second residue spread performance corresponding to a residue spread of the first agricultural harvester in a fourth harvesting area;
modify an operation parameter of the first agricultural harvester based on the second residue spread performance to obtain a second modified operation parameter; and
control the residue spread of the first agricultural harvester in a fifth harvesting area according to the second modified operation parameter.
